(19) United States
(12) Patent Application Publication
(10) Pub. No.: US 2017/0131560 A1
(43) Pub. Date: May 11, 2017

(54) DIFFRACTIVE OPTICAL ELEMENT AND LASER DIODE-DOE MODULE

(71) Applicant: AHEAD OPTOELECTRONICS, INC., New Taipei City (TW)

(72) Inventors: HONG-ZONG LIAO, New Taipei City (TW); YING-YUEH CHANG, New Taipei City (TW); CHIH-MING YEN, New Taipei City (TW)

(21) Appl. No.: 14/706,401

(22) Filed: May 7, 2015

(30) Foreign Application Priority Data
Nov. 14, 2014 (TW) 103139607
Nov. 14, 2014 (TW) 103220315

(51) Int. Cl. G02B 27/42; G02B 27/09

(52) U.S. Cl. CPC G02B 27/4233; G02B 27/0944

(57) ABSTRACT

A laser diode-DOE module includes a diffractive optical element and a laser light source. The diffractive optical element receives a non-collimated dot beam. The laser light source emits a non-collimated dot beam. Consequently, the spacing distance between the laser light source and the diffractive optical element can be designed as short as possible. Consequently, the total length of the laser diode-DOE module is reduced.

### FIELD OF THE INVENTION

The present invention relates to a laser diode-diffractive optical element module (also referred as a DOE module), and more particularly to an integrated module of a laser diode and a diffractive optical element.

### BACKGROUND OF THE INVENTION

Generally, mobile devices such as smart phones are essential electronic devices for most people in the modern societies. As the trends of designing touch pads are toward the large-size touch pads, mobile devices have sufficient spaces to accommodate requisite components. However, in addition to the large-size touch pads, the trends of designing mobile devices are also toward light weightiness and slimness. Consequently, if some components of the mobile device have to be installed in the mobile device in a specified fashion because of the required functions or other factors, the thicknesses and the sizes of these components are directly related to the thickness of the mobile device. For example, in most commercially-available smart phones, the thickness of the lens module is larger than the thickness of the smart phone. Consequently, after the lens module is accommodated within the smart phone, the position of the lens module is usually protruded over the case of the smart phone. Under this circumstance, the smart phone is not aesthetically pleasing.

As mentioned above, the smart phone is equipped with the lens module. In addition, the trend of designing the smart phone is toward the integration of a component having a projecting function. FIG. 1 is a schematic side view illustrating a conventional projection light source. As shown in FIG. 1, a general laser diode 12 emits a dot beam 13. After the dot beam 13 is received by a collimator 14, the dot beam 13 is collimated as a collimated light beam 15 by the collimator 14. After the collimated light beam 15 is received by a diffractive optical element (DOE) 16, the collimated light beam 15 is diffracted by the diffractive optical element 16. Consequently, a desired diffracted light beam 17 is outputted from the diffractive optical element 16. In the above light source configuration, the working distance between the laser diode 12 and the collimator 14 should be fixed and have high accuracy. Consequently, the assembling cost is very high. Moreover, since this light source requires the above three components, the overall length or thickness is also very large. In other words, it is difficult to install the light source in the slim-type mobile device.

### SUMMARY OF THE INVENTION

An object of the present invention provides a diffractive optical element and a laser diode-DOE module integrating the laser diode-diffractive optical element. The diffractive optical element is capable of receiving and processing a non-collimated light beam. When the diffractive optical element is applied to a projection light source, the collimator is omitted and thus the assembling cost is reduced.

Another object of the present invention provides a diffractive optical element and a laser diode-DOE module integrating the laser diode-diffractive optical element. There is no collimator between the diffractive optical element and the laser diode. Since the overall length is reduced, the laser diode-DOE module is suitably applied to a mobile device such as a smart phone.

Another object of the present invention provides a diffractive optical element and a laser diode-DOE module integrating the laser diode-diffractive optical element. The diffractive optical element has a concave lens structure with a beam-expandable function. Consequently, when the light beam reaches the diffractive optical element in a short distance, the area of the light beam striking the diffractive optical element is sufficient.

Another object of the present invention provides a diffractive optical element and a laser diode-DOE module integrating the laser diode-diffractive optical element. After a non-collimated light beam passes through the diffractive optical element, a desired diffractive output light is generated.

In accordance with an aspect of the present invention, there is provided a laser diode-DOE module. The laser diode-DOE module includes a laser light source and a diffractive optical element. The laser light source emits a non-collimated dot beam. The diffractive optical element receives the non-collimated dot beam from the laser light source, and modulates the non-collimated dot beam as an optical information-bearing light.

In an embodiment, the laser diode-DOE module further includes a case. The laser light source and the diffractive optical element are accommodated within the case.

In an embodiment, the diffractive optical element includes a transparent substrate and a microstructure. The microstructure is formed on a first surface of the transparent substrate, and the non-collimated dot beam is diffracted by the microstructure.

In an embodiment, the first surface of the transparent substrate with the microstructure is a flat surface or a curvy surface.

In an embodiment, the microstructure is distributed over a part or an entire of the first surface of the transparent substrate.

In an embodiment, the microstructure is located at an outer side of the first surface and exposed outside the first surface, or the microstructure is located at an inner side of the first surface.

In an embodiment, the first surface of the transparent substrate faces the laser light source or faces an external side of the laser diode-DOE module.

In an embodiment, the diffractive optical element further includes a beam-expandable functional structure. The beam-expandable functional structure is formed on or disposed on a second surface of the transparent substrate. The non-collimated dot beam passes through the beam-expandable functional structure.

In an embodiment, the beam-expandable functional structure includes a concave lens structure with a geometric optical surface. The concave lens structure is produced by a semiconductor production process or a precise machining process.

In an embodiment, the first surface of the transparent substrate is arranged between the laser light source and the second surface of the transparent substrate, or the second surface of the transparent substrate is arranged between the laser light source and the first surface of the transparent substrate.

In an embodiment, there is a spacing distance between the laser light source and the transparent substrate, wherein the spacing distance is 0 or not 0.

In accordance with another aspect of the present invention, there is provided a diffractive optical element. The diffractive optical element includes a transparent substrate and a microstructure. The non-collimated dot beam is received by the microstructure. The microstructure is formed on the transparent substrate.

In an embodiment, the diffractive optical element further includes a beam-expandable functional structure. The microstructure is located at a first surface of the transparent substrate. The beam-expandable functional structure is located at a second surface of the transparent substrate.

In an embodiment, the microstructure is distributed over a part or an entire of the first surface of the transparent substrate.

In an embodiment, the beam-expandable functional structure includes a concave lens structure. The concave lens structure is distributed over a part or an entire of the second surface of the transparent substrate.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic side view illustrating a conventional projection light source;

FIG. 2 is a schematic side view illustrating a laser diode-DOE module according to an embodiment of the present invention;

FIG. 3 is an enlarged side view illustrating an exemplary diffractive optical element of the present invention;

FIG. 4 is an enlarged side view illustrating another exemplary diffractive optical element of the present invention;

FIG. 5 is an enlarged side view illustrating another exemplary diffractive optical element of the present invention; and

FIG. 6 is an enlarged side view illustrating another exemplary diffractive optical element of the present invention.

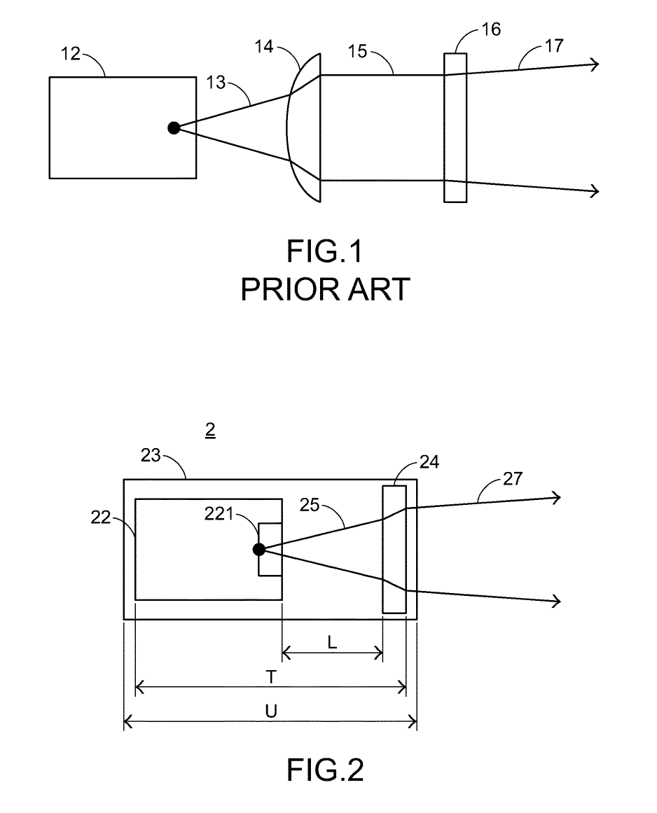

### DETAILED DESCRIPTION OF THE PREFERRED EMBODIMENT

The present invention provides a diffractive optical element and a laser diode-DOE module integrating the laser diode-diffractive optical element. The laser diode-DOE module is suitably applied to a mobile device such as a smart phone. Generally, the conventional semiconductor laser module of the smart phone with a TO-CAN package structure has a size of 6×6×7 mm (length×width×thickness). The semiconductor laser module in the advanced configuration has a size of 4×6×4 mm. That is, according to the present invention, the thickness of the laser diode-DOE module integrating the laser diode-diffractive optical element will be reduced to 4 mm or less. In case that the package structure uses a surface mount device (SMD) laser diode, the thickness of the laser module can be reduced to 2 mm so as to be applied to the handheld device. Moreover, the laser module can be directly printed on a printed circuit board (PCB) and fabricated by the conventional mounting process.

As known, the laser beam emitted by the general laser light source is a non-collimated dot beam. Conventionally, a collimator is used to collimate the non-collimated dot beam into a parallel light beam, and then the parallel light beam is introduced into another optical element. In this context, the term “non-collimated light beam” indicates the laser beam emitted by the general laser light source. Before the non-collimated light beam is introduced into the diffractive optical element of the present invention, the non-collimated light beam is not subjected to any collimating process. Consequently, the non-collimated light beam has a beam divergence that is not equal to zero degree. The diffractive optical element of the present invention can be applied to any laser light source that emits the non-collimated dot beam. Preferably but not exclusively, the laser light source is an edge emitting laser light source, a vertical cavity surface emitting laser (VCSEL) light source or any other appropriate laser light source.

FIG. 2 is a schematic side view illustrating a laser diode-DOE module according to an embodiment of the present invention. As shown in FIG. 2, the laser diode-DOE module 2 comprises a laser light source 22 and a diffractive optical element 24. The laser diode-DOE module 2 may further comprise a case 23. The laser light source 22 and the diffractive optical element 24 are accommodated within the case 23. In this embodiment, a non-collimated dot beam 25 emitted by the laser light source 22 is outputted from a window 221 of the laser light source 22. The window 221 is an opening of the laser light source 22. Optionally, an additional component (not shown) without the collimating function is located at the opening For example, the additional component is a dustproof transparent protective sheet or glue. In some other embodiments, the laser light source 22 may provide a lighting surface or a vertical cavity surface emitting laser (VCSEL) light source array for emitting plural non-collimated dot beams 25.

The diffractive optical element 24 is located in front of the laser light source 22. The non-collimated dot beam 25 is directed to the diffractive optical element 24. In accordance with the present invention, no additional optical element or structure with the collimating function is included in the laser light source 22 or interposed between the laser light source 22 and the diffractive optical element 24. Moreover, there is a spacing distance L between the diffractive optical element 24 and the laser light source 22. The spacing distance L is 0 or not 0. That is, the diffractive optical element 24 may be completely attached on the laser light source 22, or the diffractive optical element 24 may be separated from the laser light source 22 by a specified distance. If the diffractive optical element 24 of the present invention is completely attached on the laser light source 22, the total length T of the diffractive optical element 24 and the laser light source 22 (i.e., the overall length along the optical axis of the laser light source 22) can be largely reduced. Under this circumstance, the thickness U of the case 23 can be reduced to 4 mm or less.

After the non-collimated dot beam 25 is directed to and processed by the diffractive optical element 24, an optical information-bearing light 27 with two dimensions or more than two dimensions is generated. After the optical information-bearing light 27 is outputted from the laser diode-DOE module 2, the optical information-bearing light 27 is projected to any appropriate light-receiving surface or space. Moreover, since the optical information-bearing light 27 is modulated by the diffractive optical element 24, the brightness of the optical information can be uniform or have a gray level change according to the practical requirements. That is, there are no unexpected light spots beyond the designing condition. In addition to the optical information with the higher brightness, the optical information-bearing light 27 may also contain the background light with the lower brightness. In case that the optical information-bearing light 27 contains the background light, the brightness is uniform or slightly changed.

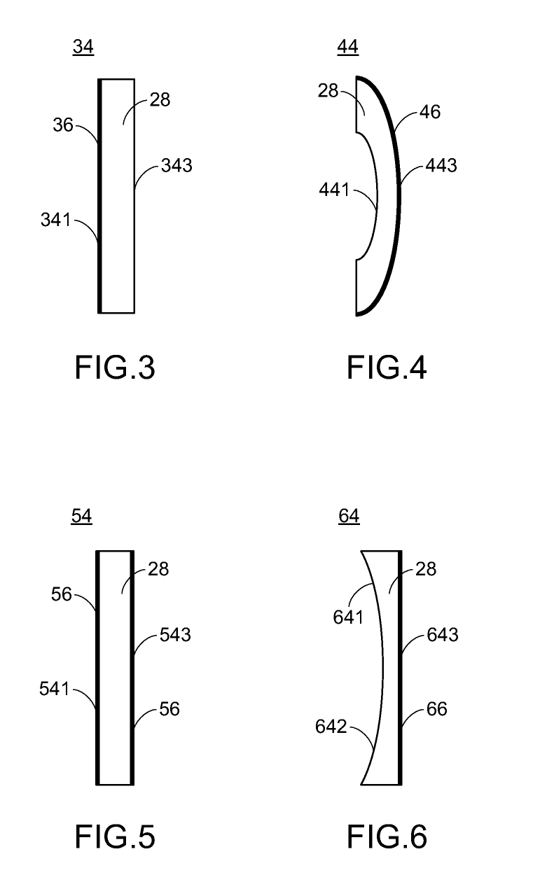

FIGS. 3, 4 and 5 are enlarged side views illustrating some exemplary diffractive optical elements of the present invention. As shown in FIGS. 3, 4 and 5, each of the diffractive optical elements 34, 44 and 54 comprises a transparent substrate 28. The transparent substrate 28 is made of a light-transmissible material. Moreover, a microstructure with diffractive textures or patterns is disposed on or formed on at least one surface of the transparent substrate 28. As shown in FIG. 3, a surface 341 of the transparent substrate 28 faces the laser light source, the optical information-bearing light is outputted from a surface 343 of the transparent substrate 28, the microstructure 36 with diffractive textures or patterns for receiving the non-collimated dot beam is disposed on the surface 341 of the transparent substrate 28, and the surface 343 of the transparent substrate 28 has no microstructure. For example, the microstructure 36 is a UV curable adhesive layer that is disposed on and exposed to the surface 341 of the transparent substrate 28, or the microstructure 36 is a textured layer that is formed on an outer side of the surface 341 of the transparent substrate 28 by an etching process. The diffractive optical element 44 of FIG. 4 is distinguished from the diffractive optical element 34 of FIG. 3. As shown in FIG. 4, a surface 441 facing the laser light source does not have the diffracting function, and a surface 443 has a microstructure 46 with diffractive textures or patterns for receiving the non-collimated dot beam and generating a diffracted image. As shown in FIG. 5, both of a surface 541 and a surface 543 have microstructures 56 with diffractive textures or patterns for receiving the non-collimated dot beam. It is noted that the surface of each of the diffractive optical elements 34, 44 and 54 may be a flat surface or a curvy surface with a radian or a curvature. Moreover, the diffractive textures or patterns for receiving the non-collimated dot beam may be distributed over or formed on a part or an entire of the surface of the transparent substrate.

In addition to the microstructure with diffractive textures or patterns, the diffractive optical element of the present invention may have a functional surface for providing another function. FIG. 6 is an enlarged side view illustrating another exemplary diffractive optical element of the present invention. As shown in FIG. 6, the diffractive optical element 64 also comprises a transparent substrate 28. The transparent substrate 28 is made of a light-transmissible material. A surface 641 of the diffractive optical element 64 faces the laser light source. The surface 641 of the diffractive optical element 64 has or comprises a beam-expandable structure or shape 642. For example, the beam-expandable structure or shape 642 is a concave lens structure. The concave lens structure has a geometric optical surface produced by a DOE semiconductor production process or a precise machining process. Moreover, a microstructure 66 with diffractive textures or patterns is formed on a surface 643 of the transparent substrate 28, and the optical information-bearing light is outputted from the surface 643 of the transparent substrate 28. By the diffractive optical element 64, the size of the incident non-collimated dot beam is expanded. Since the light beam passing through the microstructure 66 has a larger light-receiving area to acquire more wavefront modulation data, the projection image is more exquisite. It is noted that the beam-expandable structure or shape may be distributed over or formed on a part or an entire of the surface of the transparent substrate.

From the above descriptions, the present invention provides a laser diode-DOE module. In comparison with the conventional technology, the laser diode-DOE module of the present invention is no longer equipped with the collimator between the laser light source and the diffractive optical element. More especially, if the diffractive optical element is attached on the laser light source, the total length of the laser diode-DOE module of the present invention along the optical axis of the laser light source can be largely reduced. Under this circumstance, the material and the assembling cost of the whole laser diode-DOE module are both reduced. Consequently, the laser diode-DOE module is suitably applied to a slim-type mobile device or a wearable device.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A laser diode-DOE module, comprising:
a laser light source emitting a non-collimated dot beam; and
a diffractive optical element receiving the non-collimated dot beam from the laser light source, and modulating the non-collimated dot beam as an optical information-bearing light.

2. The laser diode-DOE module according to claim 1, further comprising a case, wherein the laser light source and the diffractive optical element are accommodated within the case.

3. The laser diode-DOE module according to claim 1, wherein the diffractive optical element comprises a transparent substrate and a microstructure, wherein the microstructure is formed on a first surface of the transparent substrate, and the non-collimated dot beam is diffracted by the microstructure.

4. The laser diode-DOE module according to claim 3, wherein the first surface of the transparent substrate with the microstructure is a flat surface or a curvy surface.

5. The laser diode-DOE module according to claim 4, wherein the microstructure is distributed over a part or an entire of the first surface of the transparent substrate.

6. The laser diode-DOE module according to claim 4, wherein the microstructure is located at an outer side of the first surface and exposed outside the first surface, or the microstructure is located at an inner side of the first surface.

7. The laser diode-DOE module according to claim 3, wherein the first surface of the transparent substrate faces the laser light source or faces an external side of the laser diode-DOE module.

8. The laser diode-DOE module according to claim 3, wherein the diffractive optical element further comprises a beam-expandable functional structure, wherein the beam-expandable functional structure is formed on or disposed on a second surface of the transparent substrate, and the non-collimated dot beam passes through the beam-expandable functional structure.

9. The laser diode-DOE module according to claim 8, wherein the beam-expandable functional structure comprises a concave lens structure with a geometric optical surface, wherein the concave lens structure is produced by a semiconductor production process or a precise machining process.

10. The laser diode-DOE module according to claim 7, wherein the first surface of the transparent substrate is arranged between the laser light source and the second surface of the transparent substrate, or the second surface of the transparent substrate is arranged between the laser light source and the first surface of the transparent substrate.

11. The laser diode-DOE module according to claim 1, wherein there is a spacing distance between the laser light source and the transparent substrate, wherein the spacing distance is 0 or not 0.

12. A diffractive optical element comprising a transparent substrate and a microstructure, wherein the non-collimated dot beam is received by the microstructure, and the microstructure is formed on the transparent substrate.

13. The diffractive optical element according to claim 12, wherein the diffractive optical element further comprises a beam-expandable functional structure, wherein the microstructure is located at a first surface of the transparent substrate, and the beam-expandable functional structure is located at a second surface of the transparent substrate.

14. The diffractive optical element according to claim 13, wherein the microstructure is distributed over a part or an entire of the first surface of the transparent substrate.

15. The diffractive optical element according to claim 13, wherein the beam-expandable functional structure comprises a concave lens structure, wherein the concave lens structure is distributed over a part or an entire of the second surface of the transparent substrate.
